(19) United States
(12) Patent Application Publication
(10) Pub. No.: US 2024/0119003 A1
(43) Pub. Date: Apr. 11, 2024

(54) LOW-LATENCY MACHINE LEARNING MODEL PREDICTION CACHE FOR IMPROVING DISTRIBUTION OF CURRENT STATE MACHINE LEARNING PREDICTIONS ACROSS COMPUTER NETWORKS

(71) Applicant: Chime Financial, Inc., San Francisco, CA (US)

(72) Inventors: Greg Tobkin, San Francisco, CA (US); Akshay Jain, Boise, ID (US); Frank Teoh, Milpitas, CA (US); Paul Zeng, New York, NY (US); Peeyush Agarwal, Mountain View, CA (US); Sashidhar Guntury, Los Angeles, CA (US)

(21) Appl. No.: 17/938,129

(22) Filed: Oct. 5, 2022

(51) Int. Cl. G06F 12/0842; G06N 20/20

(52) U.S. Cl. CPC G06F 12/0842; G06N 20/20

(57) ABSTRACT

The present disclosure relates to systems, non-transitory computer-readable media, and methods that utilize a low-latency machine learning model prediction cache for improving distribution of current state machine learning predictions across computer networks. In particular, in one or more implementations, the disclosed systems utilize a prediction registration platform for defining prediction datatypes and corresponding machine learning model prediction templates. Moreover, in one or more embodiments, the disclosed systems generate a machine learning data repository that includes predictions generated from input features utilizing machine learning models. From this repository, the disclosed systems also generate a low-latency machine learning prediction cache by extracting current state machine learning model predictions according to the machine learning prediction templates and then utilize the low-latency machine learning prediction cache to respond to queries for machine learning model predictions.

### BACKGROUND

Recent years have seen significant improvements in conventional systems for training and implementing machine learning models. For example, conventional systems utilize a variety of machine learning models with learned parameters trained to perform various prediction tasks. To illustrate, conventional systems utilize decision tree or neural network machine learning approaches to generate predictions or classifications regarding client devices. Although these conventional systems are able to generate and utilize machine learning models, they have a number of technical deficiencies in relation to efficiency, accuracy, and flexibility in distributing and accessing these results across complex computer networks.

For instance, conventional systems are often inefficient and time consuming because they employ high-latency digital data repositories to store and distribute machine learning model predictions. For example, some systems utilize a variety of different machine learning models that individually produce and store predictions in various digital locations utilizing a variety of different taxonomies. To utilize these predictions, implementing systems need to locate, request, translate, and distribute these predictions to various requesting devices. This approach requires significant time and computing resources in storing, searching, transforming, distributing, and utilizing these predictions.

Conventional systems are also inefficient in that they are inaccessible or undiscoverable to a variety of computing devices within a distributing computing network. For example, conventional systems often require accessing devices to provide detailed, in-depth, complex information regarding machine learning model versioning, pipelines, experimentation, context, implementation details, architectures, languages, and/or timing. However, identifying such information is itself a time-consuming and resource-heavy exercise. Indeed, conventional systems require extensive user interfaces, user interactions, time, computational power, and expertise to identify the needed information to distribute pertinent machine learning predictions to appropriate computing devices.

Conventional systems are also inaccurate and inflexible. Indeed, conventional systems are also unable to accurately align needed machine learning model predictions to consuming resources within a complex computer architecture. Thus, for example, a new computing system that needs a particular prediction from a particular security machine learning model is often unable to access the needed information. Moreover, because machine learning models and predictions change over time, conventional systems often provide outdated predictions from an improper machine learning model version that undermines the accuracy of the requesting system. Thus, conventional systems cannot flexibly adapt to provide accurate predictions to new computing systems that come online or to address changes in machine learning models as they develop and change over time. In addition, because of the latency issues discussed above, conventional systems often cannot function in the context of latency-sensitive workloads.

### SUMMARY

This disclosure describes one or more embodiments of methods, non-transitory computer-readable media, and systems that can solve the foregoing problems in addition to providing other benefits by utilizing a low-latency machine learning model prediction cache to improve distribution of current state machine learning predictions across computer networks. In particular, the disclosed systems can implement a reusable machine learning prediction service that accelerates model development and deployment by reducing resources required to serve predictions from new and existing models. For instance, in one or more embodiments, the disclosed systems efficiently serve pre-existing machine learning model predictions from a unified prediction persistence layer in a model-agnostic manner. In one or more implementations, the disclosed systems serve these predictions with reduced, simplified inputs (e.g., without taking specific model features at request time) with low-latency-serving so the prediction can be used as part of latency-sensitive workloads.

To illustrate, in some embodiments, the disclosed systems utilize a prediction persistence layer (e.g., a machine learning data repository) that acts as an archive of machine learning predictions that decouples prediction generation from consumption. The disclosed systems also utilize an online datastore for caching current state machine learning model predictions (e.g., the most recent prediction for any given entity), for low-latency serving and updating as new predictions are generated. In addition, the disclosed systems can utilize a prediction-fetching interface consistent with schema autogenerated clients, providing flexible prediction fetches across models, including typed protobuf prediction fetches.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a block diagram of an environment for implementing a machine learning platform system in accordance with one or more embodiments.

FIG. 2 illustrates an example diagram of providing current state machine learning model predictions in accordance with one or more embodiments.

FIG. 3 illustrates an example diagram of defining a prediction datatype and machine learning model prediction templates in accordance with one or more embodiments.

FIG. 4 illustrates an example diagram of registering machine learning model prediction instances corresponding to a machine learning model prediction template in accordance with one or more embodiments.

FIG. 5 illustrates an example diagram of providing current state machine learning model predictions utilizing a low-latency machine learning prediction cache in accordance with one or more embodiments.

FIG. 6 illustrates a diagram of searching for a machine learning model and providing a current status machine learning model prediction utilizing an API in accordance with one or more embodiments.

FIG. 7 illustrates a diagram of searching for a machine learning model and providing a machine learning model prediction utilizing a machine learning model family indicator in accordance with one or more embodiments.

FIG. 8 illustrates an example series of acts for providing machine learning model predictions utilizing a low-latency machine learning prediction cache in accordance with one or more embodiments.

FIG. 9 illustrates a block diagram of a computing device for implementing one or more embodiments of the present disclosure.

FIG. 10 illustrates an example environment for an inter-network facilitation system in accordance with one or more embodiments.

### DETAILED DESCRIPTION

This disclosure describes one or more embodiments of a machine learning platform system that utilizes a low-latency machine learning model prediction cache for improving distribution of current state machine learning predictions across computer networks. In particular, in one or more implementations, the machine-earning platform system utilizes a prediction registration platform for defining prediction datatypes (for defining cross-model prediction attributes) and corresponding machine learning model prediction templates (for defining model or family specific prediction attributes). Moreover, in one or more embodiments the machine learning platform system iteratively generates/updates a machine learning data repository over time that includes machine learning model predictions generated from input features utilizing various machine learning models. From this machine learning data repository, the machine learning platform system also generates a low-latency machine learning prediction cache by extracting current state machine learning model predictions according to the machine learning prediction templates. For example, the machine learning platform system extracts the most recent machine learning model predictions for each family of machine learning models (and each entity) and then utilizes the low-latency machine learning prediction cache to respond to real-time queries for machine learning model predictions.

As just mentioned, in one or more implementations, the machine learning platform system utilizes a registration platform to define prediction datatypes and corresponding machine learning model prediction templates. The machine learning platform system can utilize these prediction templates to provide consistent, uniform machine learning predictions across different models and across predictions within model families for efficient and accurate consumption by downstream resources. Indeed, by defining a prediction datatype and prediction templates, the machine learning platform system can validate that prediction records written to the persistence layer are complete, provide strongly-typed interfaces to external teams, react to model updates, and autogenerate client code to distribute to external teams. Moreover, this approach allows computing devices to query what models and schema versions exist for fetching predictions and updating network components as machine learning models change over time.

In one or more implementations, the machine learning platform system aggregates machine learning model predictions from various machine learning models into a machine learning data repository. For example, the machine learning platform system can monitor machine learning model outputs and extract predictions and corresponding entity features to maintain within the machine learning data repository. Thus, the machine learning platform system can generate a machine learning data repository that reflects historical and current state machine learning predictions across models and model families.

As discussed above, in some implementations the machine learning platform system extracts and aggregates current state machine learning model predictions to generate a low-latency machine learning prediction cache. For instance, the machine learning platform system determines a recency order of machine learning model predictions for a particular model and/or model family and extracts machine learning model predictions based on the recency order. In one or more embodiments, the machine learning platform system extracts the most recent machine learning model prediction for each entity (and each model family) to generate the low-latency machine learning prediction cache. Moreover, the machine learning platform system extracts these predictions in accordance with the machine learning prediction templates discussed above. Accordingly, this online repository can quickly and efficiently provide current state machine learning model predictions to prediction requester devices.

In one or more implementations, the machine learning platform system provides a prediction-serving application programming interface that allows prediction requester devices to query predictions from the low-latency machine learning prediction cache. In particular, the machine learning platform system utilizes an application programming interface that fetches predictions using schema-generated client code. Moreover, by generating machine learning model predictions consistent with a defined prediction datatype and one or more machine learning prediction templates, the machine learning platform system can accurately and efficiently identify machine learning predictions utilizing such client code. Indeed, in one or more implementations, the machine learning platform system maintains the machine learning model predictions within the low-latency machine learning model prediction cache in the form of protobufs (or JSON string encoding of protobufs).

The machine learning platform system can provide several improvements or advantages relative to conventional systems discussed above. For example, the machine learning platform system can significantly improve efficiency relative to conventional systems. Indeed, by utilizing a low-latency machine learning prediction cache to store current state machine learning model predictions, the machine learning platform system can significantly reduce time and computing resources needed to identify and provide machine learning predictions to requester devices. Indeed, the machine learning platform system can utilize an online repository with significantly lower latency to cache and retrieve the most recent machine learning predictions for a particular model family and entity to significantly reduce resources needed to locate, search, identify, and provide machine learning predictions.

In addition, the machine learning platform system also improves efficiency by making machine learning predictions more accessible. For instance, by using a prediction prototype and machine learning model prediction templates, the machine learning platform system can create a uniform, consistent structure for machine learning model predictions that becomes visible and accessible to computing devices across the network. Thus, computing devices can search for pertinent machine learning models and corresponding predictions that may be pertinent to any particular application. Furthermore, the machine learning platform system can identify machine learning model predictions with simplified, streamlined query information, such as machine learning model name and entity. Indeed, the machine learning platform system need not require computing devices or users to know complex information regarding machine learning model versioning, language protocols, timing, context, or architectures to obtain pertinent machine learning model predictions. By efficiently storing and accessing machine learning model predictions, the machine learning platform system can provide more efficient user interfaces that allow computing devices to identify models, model families, and or model predictions with significantly reduced time and computing resources.

The machine learning platform system also improves efficiency by reducing load on engineering devices in launching/deploying new models. Indeed, conventional systems often require significant computing protocols, analysis, and logic for each individual model. In contrast, the machine learning platform system allows engineering devices to register a new machine learning model and then utilize a dynamic schema that allows the machine learning model predictions to automatically flow to a low-latency machine learning prediction cache to prediction consuming devices. Accordingly, the machine learning platform system significantly reduces processing power and resources for engineering devices in implementing per model specific logic.

Furthermore, the machine learning platform system also improves accuracy and flexibility. Indeed, the machine learning platform system can accurately align needed machine learning model predictions with various network components. Indeed, as new prediction requester network components come online, the machine learning platform system provides a flexible and accurate mechanism for identifying pertinent machine learning models and corresponding predictions. Furthermore, as machine learning models change over time, the machine learning platform system dynamically updates prediction instances and the low-latency machine learning prediction cache to seamlessly provide accurate machine learning model predictions across the computer network. In addition, in one or more embodiments, the machine learning platform system utilizes a model-agnostic prediction datatype with flexible machine learning model templates to distribute consistent and accurate predictions across models and across predictions within individual models/model families. Moreover, because of the improved latency, the machine learning platform system can operate with real-time latency-sensitive workloads and applications.

As indicated by the foregoing discussion, the present disclosure utilizes a variety of terms to describe features and advantages of the machine learning platform system. For example, as used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that change based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

As used herein, the term “neural network” refers to a machine learning model of interconnected artificial neurons (e.g., organized in layers) that communicate and learn to approximate complex functions and generate outputs based on a plurality of inputs provided to the neural network. In some cases, a neural network refers to an algorithm (or set of algorithms) that implements deep learning techniques to model high-level abstractions in data. For example, a neural network includes a multi-layer perceptron, a transformer neural network, a convolutional neural network, a recurrent neural network (e.g., an LSTM), a graph neural network, or a generative adversarial neural network.

As used herein, the term “machine learning model prediction” refers to an inference, estimate, our output of a machine learning model. For example, a machine learning model prediction can include a predicted classification, a predicted feature, or a predicted digital media item (e.g., a digital image generated by a generative neural network). Thus, for a security machine learning model, a machine learning prediction can include a Boolean prediction of whether a client device is authentic or synthetic. Similarly, for an intent classification machine learning model a prediction can include a predicted intent class corresponding to a client device.

As mentioned above, the machine learning platform system can extract current state machine learning model predictions. As used herein, the term “current state machine learning model predictions” (or “current state predictions”) refers to a current or recent machine learning model prediction. For example, the machine learning platform system can extract a current state machine learning model prediction by identifying a most recent (or most current) prediction from a machine learning model or machine learning model family corresponding to a particular entity. In one or more implementations, the machine learning platform system extracts the current state machine learning model prediction for each machine learning model family from a machine learning data repository (e.g., a memory device such as a server) and stores the current state machine learning model in a low-latency machine learning prediction cache (e.g., an online memory with lower latency than the machine learning data repository).

In one or more implementations, the machine learning platform system utilizes machine learning models to make predictions from input features. As used herein, “input features” (or “features” or “entity features”) refers to characteristics, information, or data utilized to generate a machine learning prediction. For example, a machine learning model can make a prediction regarding an entity (e.g., a client device, person, account) based on features corresponding to the entity.

As mentioned above, the machine learning platform system can define a prediction datatype and/or machine learning model prediction template. As used herein a “prediction datatype” refers to a set of parameters defining the format, data shape, or permissible characteristics of a machine learning prediction across machine learning models. In particular, a prediction datatype can include fields and a permissible type of data for the fields that can be used across machine learning models for a machine learning model prediction. Examples of prediction datatypes are discussed in greater detail below.

Similarly, as used herein, the term “machine learning model prediction template” refers to a set of parameters (e.g., that comply with a prediction datatype) that define the format, data shape, or permissible characteristics of a machine learning prediction for a machine learning model. In particular, a machine learning model template can include a permissible set of parameters that can be used for predictions within a machine learning model. To illustrate, a prediction datatype can define general parameters for a machine learning model name field, a machine learning model prediction field, and a machine learning model entity feature field. A machine learning model prediction template can define a particular name for a machine learning model (in accordance with the prediction datatype), and define prediction data parameters and/or entity feature data parameters that correspond to the machine learning model.

The machine learning platform system can also generate machine learning model prediction instances according to the machine learning model prediction templates. For instance, a machine learning model prediction instance includes a prediction that satisfies the parameters of a machine learning prediction template. In particular, a machine learning prediction instance includes data values (e.g., machine learning model prediction value and/or entity feature data value) populating fields that satisfy parameters of a machine learning model prediction template corresponding to the machine learning model.

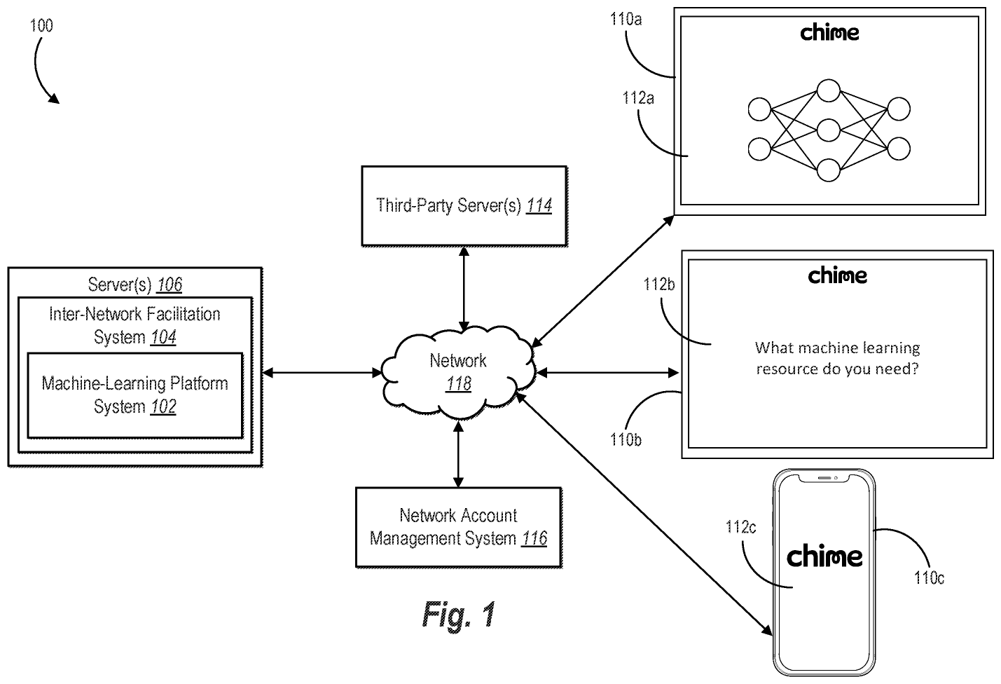

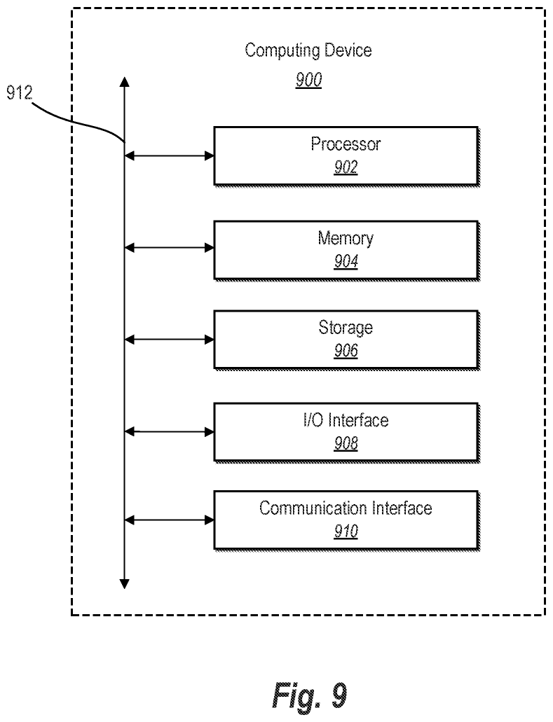

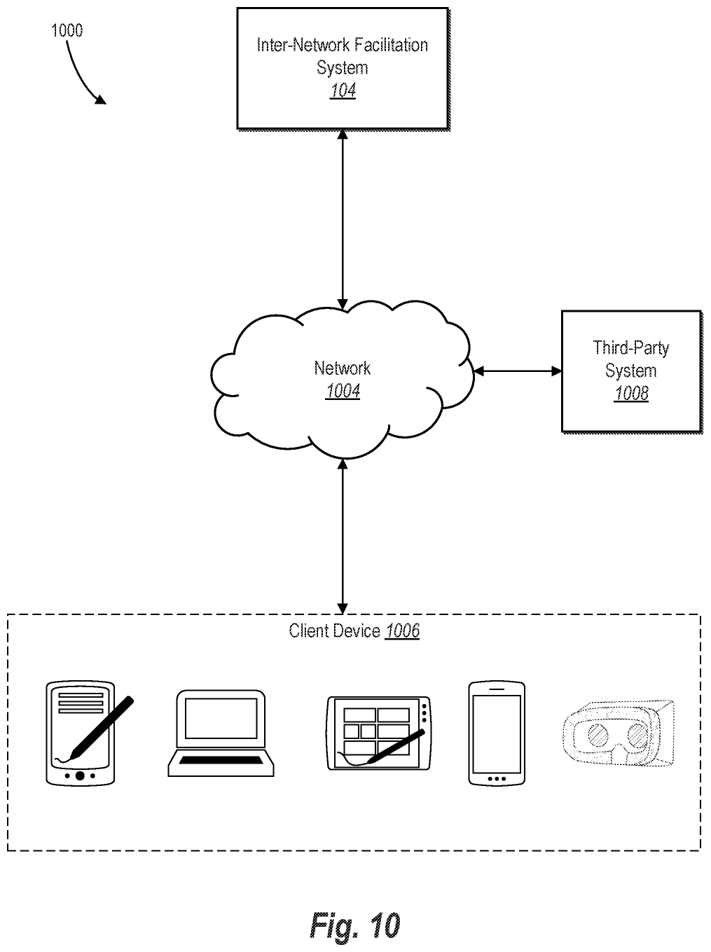

Additional detail regarding the machine learning platform system will now be provided with reference to the figures. In particular, FIG. 1 illustrates a computing system environment for implementing a machine learning platform system 102 in accordance with one or more embodiments. As shown in FIG. 1, the environment includes server(s) 106, a variety of client devices (e.g., model engineering device(s) 110a, prediction requester device(s) 110b, and member client device(s) 110c), third-party server(s) 114, and a network account management system 116. Each of the components of the environment 100 communicate (or are at least configured to communicate) via the network 118, and the network 118 may be any suitable network over which computing devices can communicate. Example networks are discussed in more detail below in relation to FIGS. 9-10.

As further illustrated in FIG. 1, the environment 100 includes the server(s) 106. In some embodiments, the server(s) 106 comprises a content server, a historical data (feature store) server, and/or a data collection server. Additionally or alternatively, the server(s) 106 comprise an application server, a communication server, a web-hosting server, a social networking server, a digital content management server, a machine learning model development server, or a financial payment server.

Moreover, as shown in FIG. 1, the server(s) 106 implement an inter-network facilitation system 104. As described in greater detail below (e.g., in relation to FIG. 10), the inter-network facilitation system 104 can manage interactions across multiple devices, providers, and computer systems. For example, the inter-network facilitation system 104 can execute transactions across various third-party systems such as a banking entities, automated transaction machines, or payment providers. The inter-network facilitation system 104 can also maintain and manage digital accounts for client devices/users to store, manage, and/or transfer funds to other users.

Further, the environment 100 includes a variety of client devices, including the model engineering device(s) 110a, the prediction requester device(s) 110b, and the member client device(s) 110c. These client devices can include one of a variety of computing devices, including a smartphone, tablet, smart television, desktop computer, laptop computer, virtual reality device, augmented reality device, or other computing device as described in relation to FIGS. 9-10. Although FIG. 1 illustrates only a single instance of these client devices, the environment 100 can include many different client devices connected to each other via the network 118.

Further, in some embodiments, model engineering device(s) 110a assist in generating and managing machine learning models for the machine learning platform system 102. For example, the machine learning platform system 102 can provide user interfaces illustrating machine learning model parameters, training/implementations pipelines, and/or containers for selection/modification by the model engineering device(s) 110a. The machine learning platform system 102 can utilize the preferences, settings, parameters, and training data identified by the model engineering device(s) 110a to train or implement a machine learning model. Moreover, in one or more embodiments, the model engineering device(s) 110a can include user interfaces for registering machine learning models, including defining machine learning model prediction templates for various machine learning models.

During inference time, the machine learning platform system 102 can interact with the member client device(s) 110c to identify features and generate/provide predictions. For example, in implementing a security machine learning model, the machine learning platform system 102 can train the security machine learning model (based on information monitored from accounts and/or previous client interactions), identify features of the member client device(s) 110c, and predict whether the member client device(s) 110c is a synthetic client (e.g., a digital pirate or fraudulent user) attempting to access or utilize a digital account corresponding to the inter-network facilitation system 104. Similarly, in implementing an automated client interaction machine learning model, the machine learning platform system can extract features regarding the member client device(s) 110c, and utilize the machine learning model to generate an automated interaction response for the member client device(s) 110c.

The machine learning platform system 102 can also interact with the prediction requester device(s) 110b. For example, the machine learning platform system 102 can provide user interfaces to the prediction requester device(s) 110b for querying machine learning models and/or machine learning model predictions. Moreover, the machine learning platform system 102 can also respond to queries by identifying machine learning models and providing machine learning model predictions. In some implementations, the prediction requester device(s) 110b are headless devices (e.g., servers or other computing devices without user interfaces). The machine learning platform system 102 can provide machine learning model predictions to such provider devices (e.g., as part of an automatic member client device authentication process implemented by the prediction requester device(s) 110b.

Moreover, as shown, the client devices include corresponding client applications 112a-112c. The client applications 112a-112c can each include a web application, a native application installed on the client devices 110a-110c (e.g., a mobile application, a desktop application, a plug-in application, etc.), or a cloud-based application where part of the functionality is performed by the server(s) 106. In some embodiments, the machine learning platform system 102 causes the client applications 112a-112c to present or display information to a user associated with the client devices 110a-110c, including information relating to one or more different pre-defined model container workflows or machine learning model predictions.

Further shown in FIG. 1, the environment 100 includes the third-party server(s) 114. In one or more embodiments, the third-party server(s) 114 include one or more servers for data repositories, testing platforms, integration/delivery (CI/CD) platforms, etc. Accordingly, the third-party server(s) 114 can communicate with the client devices 110a-110c and/or the machine learning platform system 102 to provide certain inputs for training or implementing machine learning models.

In addition, the machine learning platform system 102 can communicate with the network account management system 116 regarding one or more network transactions. For example, the machine learning platform system 102 can communicate with the network account management system 116 to identify one or more of transaction data, network account data, device data corresponding to consumer client devices, etc.

In some embodiments, though not illustrated in FIG. 1, the environment 100 has a different arrangement of components and/or has a different number or set of components altogether. For example, in certain embodiments, the client devices 110a-110c communicate directly with the server(s) 106, bypassing the network 118. Although FIG. 1 illustrates, the machine learning platform system 102 implemented on the server(s) 106, the machine learning platform system 102 can be implemented by a variety of different devices illustrated in FIG. 1 (e.g., one or more of the client devices 110a-110c).

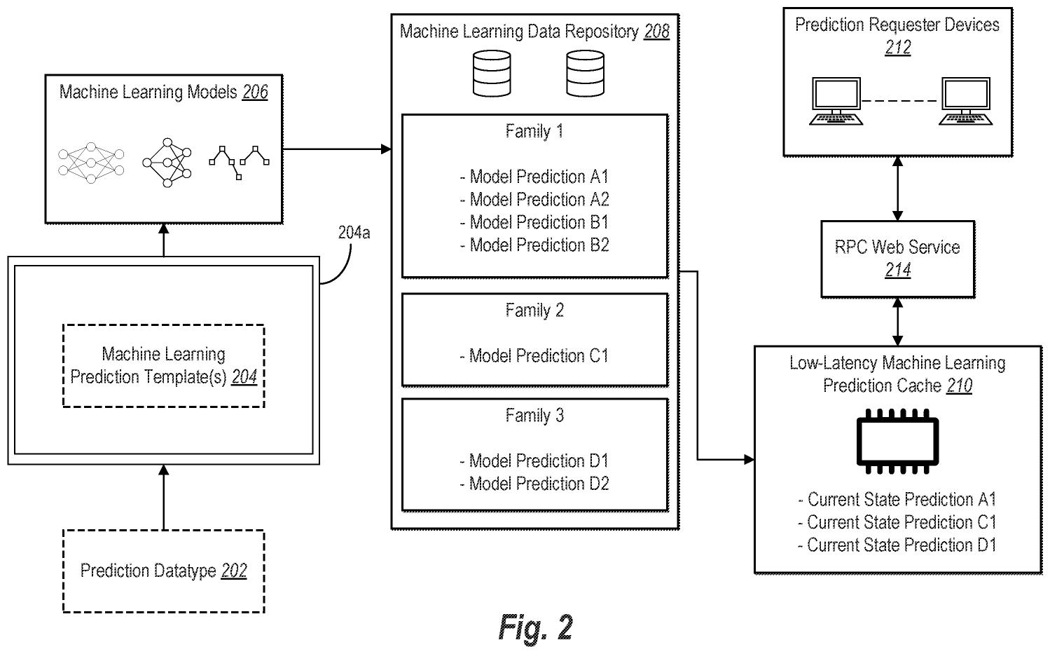

As discussed above, the machine learning platform system 102 can generate, store, and distribute machine learning model predictions. For example, FIG. 2 illustrate the machine learning platform system 102 generating machine learning predictions, extracting current state machine learning model predictions to a low-latency machine learning prediction cache 210 and distributing one or more of the current state machine learning models to prediction requester devices 212 in accordance with one or more embodiments.

In particular, FIG. 2 illustrates the machine learning platform system 102 generating machine learning model predictions utilizing machine learning models 206, a prediction datatype 202, and machine learning prediction template(s) 204. Indeed, in one or more embodiments, the machine learning platform system 102 defines a prediction datatype 202 that defines general parameters for machine learning model predictions across the machine learning models 206. Based on the prediction datatype 202, the machine learning platform system 102 also generates the machine learning prediction template(s) 204. For example, the machine learning prediction template(s) 204 can include parameters for machine learning model predictions corresponding to individual machine learning models (or machine learning model families). As illustrated, the machine learning platform system 102 can generate the machine learning prediction template(s) 204 based on user interaction with engineering computing device(s) 204a.

As shown, the machine learning platform system 102 utilizes the machine learning models 206 to generate machine learning model predictions in accordance with the machine learning prediction template(s) 204. Indeed, in one or more implementations, the machine learning platform system 102 imposes one or more typing rules or algorithms to enforce the parameters of the machine learning prediction template(s) 204 on machine learning model predictions generated by the machine learning models 206.

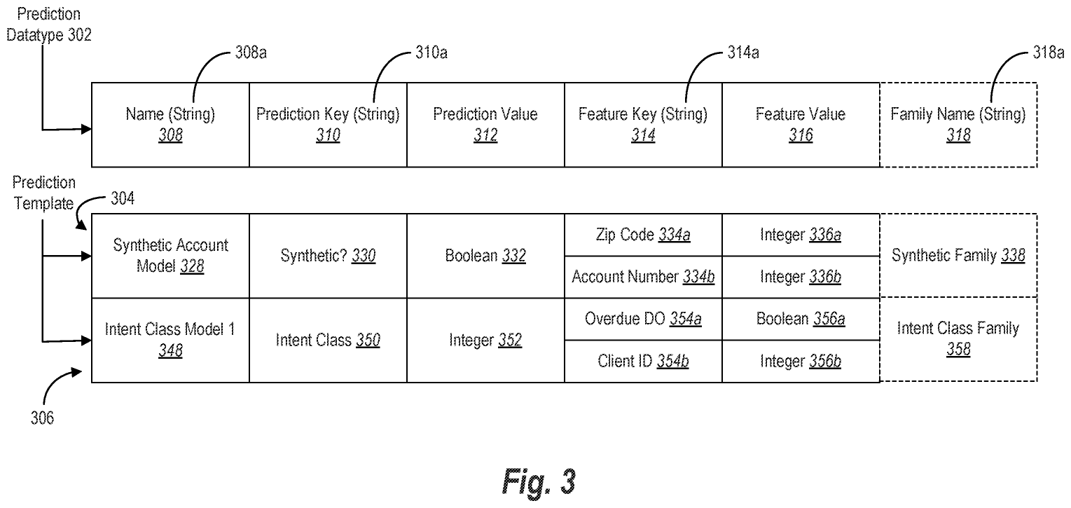

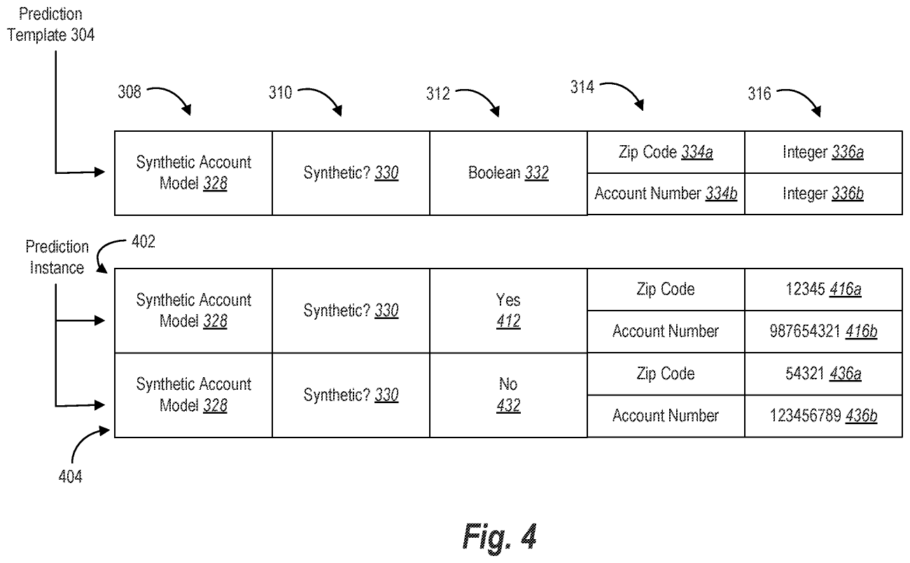

The machine learning models 206 can include a variety of machine learning models (e.g., decision trees, neural networks, support vector machines). In one or more embodiments, the machine learning platform system 102 imposes the machine learning prediction template(s) 204 within the machine learning models 206 themselves. In other implementations, the machine learning platform system 102 imposes the parameters of the machine learning prediction template(s) 204 in extracting machine learning model predictions to the machine learning data repository 208 and/or extracting machine learning model predictions to the low-latency machine learning prediction cache 210. Additional detail regarding prediction datatypes, machine learning prediction templates, and machine learning model prediction instances is provided below (e.g., in relation to FIGS. 3-4).

As shown, the machine learning platform system 102 generates the machine learning data repository 208 by extracting machine learning model predictions from the machine learning models 206. Indeed, the machine learning platform system 102 can monitor application of the machine learning models 206 and identify machine learning model predictions from machine learning models and machine learning model families over time.

As used herein, the term “machine learning model family” (or “model family”) refers to a collection of related machine learning models. In particular, a machine learning model family can include machine learning models with a common purpose (e.g., that generate a common type of prediction). For example, a first machine learning model family can include multiple versions of security machine learning models that each generate predictions regarding whether a client device is synthetic/fraudulent. Similarly, a second machine learning model family can include multiple versions of intent classification models that determine dispositions or intentions of client devices. Each model within a machine learning model can generate a plurality of predictions for the same (or different) entities.

Thus, for example, FIG. 2 illustrates that the machine learning platform system 102 monitors the machine learning models 206 and identifies a machine learning model from a first family (“Family 1”). In particular, a first machine learning model in the first model family generates two predictions A1, A2 regarding an entity. Similarly, a second machine learning model in the first model family generates two predictions B1, B2 regarding the entity.

In addition, for a second model family (i.e., “Family 2”), the machine learning platform system 102 identifies only a single machine learning model prediction (i.e., “Model Prediction C1”). Moreover, for a third model family (i.e., “Family 3”), the machine learning platform system 102 identifies two model predictions D1, D2 regarding an entity (e.g., a user account).

Although FIG. 2 illustrates a particular number of families and predictions, in one or more embodiments, the machine learning platform system 102 utilizes the machine learning data repository 208 to monitor dozens (or hundreds) of machine learning models generating thousands (or millions) of predictions regarding various entities. Indeed, the machine learning platform system 102 can utilize the machine learning models 206 to generate predictions regarding each client account or client device of the inter-network facilitation system.

The machine learning data repository 208 can include a variety of devices or systems for storing and retrieving digital information. In one or more implementations, the machine learning data repository 208 includes an offline or high-latency server (e.g., latency of 1 minute or more). For example, in one or more implementations, the machine learning data repository 208 is a prediction persistence layer that stores each prediction produced by batch or real-time models, alongside relevant associated fields (e.g., features, timestamps, model versions, etc.). Thus, the machine learning data repository 208 can include an offline prediction store that is decoupled from prediction consumers and producers.

Prediction producers can utilize the machine learning data repository 208 as a permanent archive of predictions for serving, monitoring, debugging, or auditing predictions across machine learning models. Similarly, prediction consumers can utilize the machine learning data repository 208 to detect and consume newly-produced predictions, from all models.

As shown in FIG. 2, the machine learning platform system 102 extracts current state machine learning model predictions from the machine learning data repository 208 and stores the current state machine learning model predictions in the low-latency machine learning prediction cache 210. Specifically, the machine learning platform system 102 determines a recency of the machine learning model predictions within each model family and extracts the current state machine learning model predictions based on the recency. For example, in relation to FIG. 2, the machine learning platform system 102 extracts the most recent (or most current) machine learning model prediction from each model family (and for each entity) in the machine learning data repository 208. Thus, in relation to FIG. 2, the machine learning platform system 102 extracts the machine learning model prediction A1, the machine learning model prediction C1, and the machine learning model prediction D1 (i.e., the most recent machine learning model prediction from Family 1, Family 2, and Family 3).

The low-latency machine learning prediction cache 210 can include an online server or memory device. As indicated, the low-latency machine learning prediction cache 210 includes an online datastore with lower latency relative to the machine learning data repository 208. For example, in some implementations, the low-latency machine learning prediction cache 210 has a latency (of 100 ms or less). Although the machine learning platform system 102 can utilize a variety of memory devices, in one or more embodiments, the machine learning platform system 102 utilizes an online data store, such as DynamoDb. Furthermore, in one or more embodiments, the machine learning platform system 102 also leverages AWS DAX in-memory caching to further improve latency. Indeed, the machine learning platform system 102 can provide latency in some instances in less than twenty seconds. Indeed, some experiments have yielded results in less than four milliseconds.

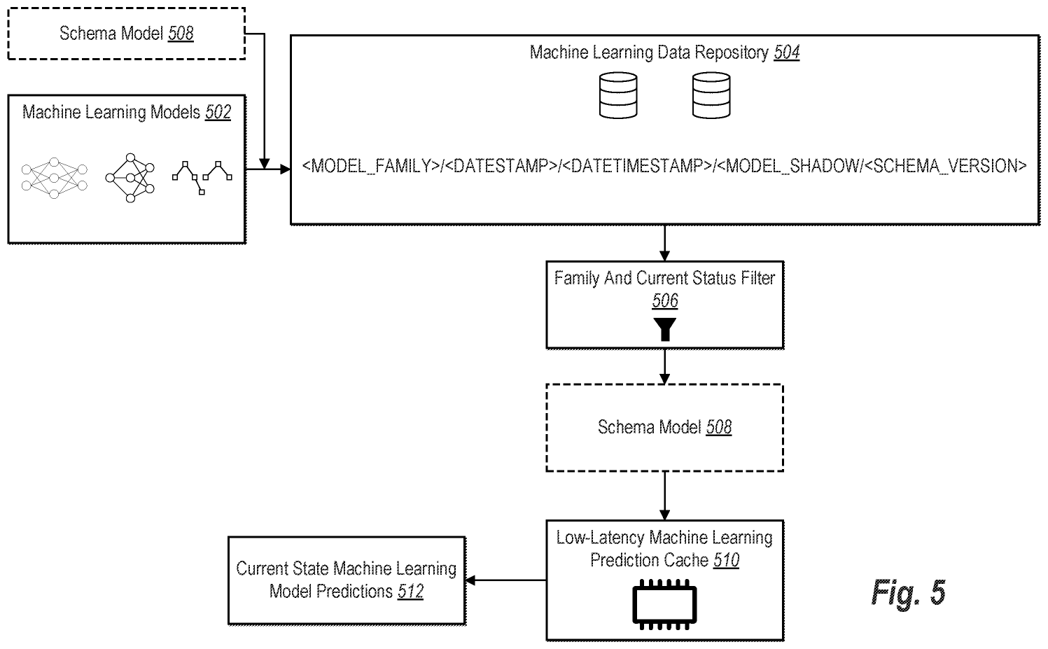

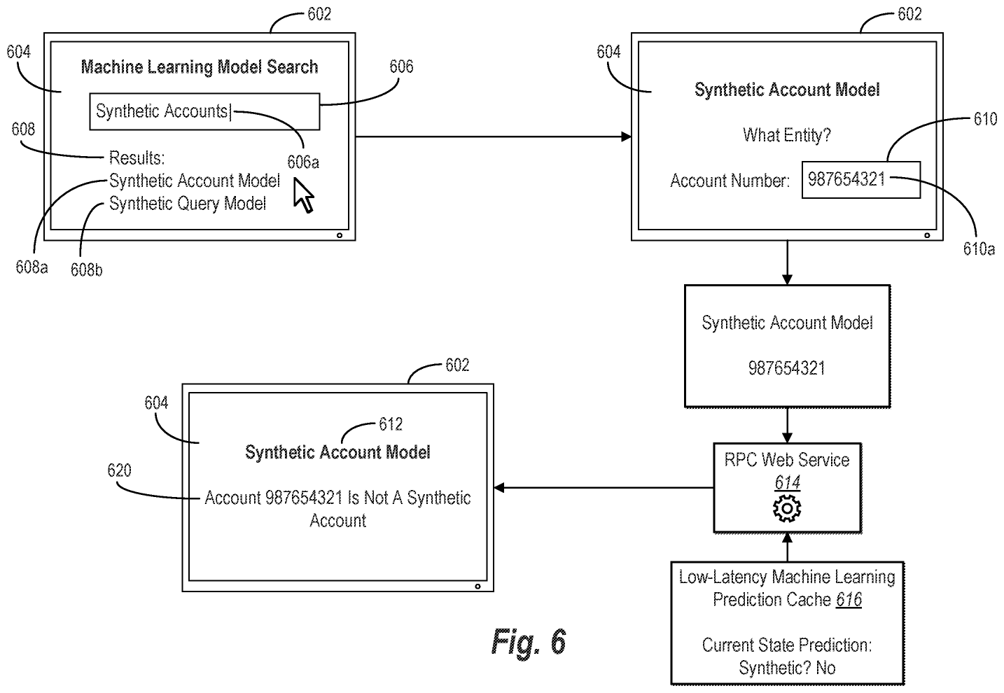

As illustrated in FIG. 2, the machine learning platform system 102 utilizes the low-latency machine learning prediction cache 210 and a corresponding remote procedure call (or RPC) web service 214 to provide current state machine learning model predictions to prediction requester devices 212. For example, the machine learning platform system 102 can receive, via the RPC web service 214 (or an application program interface) a query from a prediction requester device for a prediction related to a particular entity (e.g., a client device). The machine learning platform system 102, via the RPC web service 214, can fetch the current state machine learning model prediction for that entity (e.g., the most recent prediction for the entity) and provide the current state machine learning model prediction. Because the low-latency machine learning prediction cache 210 is limited to current state machine learning model predictions and implemented as an online datastore, the machine learning platform system 102, via the RPC web service 214, can provide predictions significantly faster and more efficiently than conventional systems. Additional detail regarding utilizing an application program interface to generate responses to machine learning model prediction queries is provided below (e.g., in relation to FIGS. 5-6)

The prediction requester devices 212 can include a variety of computing devices related to a variety of network components of the inter-network facilitation system 104. For example, the machine learning platform system 102 can serve machine learning model predictions for a variety of network components, such as account authorization devices, security analysis systems, risk analysis systems, transaction verification/authorization systems, etc. Because all of these network components routinely query machine learning model predictions, the machine learning platform system 102 can significantly improve the overall bandwidth and efficiency of the inter-network facilitation system 104.

As mentioned above, in one or more implementations, the machine learning platform system 102 generates a prediction datatype and machine learning model prediction templates. For example, FIG. 3 illustrates a prediction datatype 302 and machine learning model prediction templates 304, 306 in accordance with one or more embodiments.

Specifically, the prediction datatype 302 includes a name field 308, machine learning model prediction fields (i.e., a prediction key field 310 and a prediction value field 312), machine learning model entity feature fields (i.e., a feature key field 314 and a feature value field 316), and a family name field 318. In addition, the prediction datatype 302 also includes parameters for one or more of the fields (e.g., parameters 308a, 310a, 314a, and 318a). For example, the name field 308 includes a parameter 308a requiring that the name field be populated with a string data type. Similarly, the prediction key field 310 and the feature key field 314 have corresponding parameters 310a, 314a requiring string data types.

In one or more embodiments, the machine learning platform system 102 defines the prediction datatype 302 and/or modifies the prediction datatype 302. For example, the machine learning platform system 102 can define the prediction datatype 302 based on user interaction via a user interface (e.g., user entry of fields and/or parameters).

In one or more embodiments, the prediction datatype 302 defines requirements or structures for machine learning model prediction templates across machine learning models. For example, the prediction datatype 302 requires that machine learning model prediction templates (and prediction instances) define a name having a string data type. Thus, the machine learning platform system 102 can impose structural parameters over a variety of machine learning model predictions to improve efficiency and functionality in locating and providing machine learning predictions across computer networks. In addition, the machine learning platform system 102 can also provide flexibility that allows for implementation across a variety of different machine learning models with a variety of different types of predictions or applications.

Indeed, as shown, the machine learning platform system 102 defines the machine learning model prediction templates 304, 306. The machine learning model prediction template 304 includes a name 328 for the name field 308 that complies with the parameter 308a. Similarly, the machine learning model prediction template 304 includes a prediction key name 330 (i.e., “Synthetic?”) for the prediction key field 310 that complies with the parameter 310a (i.e., the prediction key name 330 is a string).

Moreover, the machine learning model prediction template 304 also includes a prediction value parameter 332 (i.e., “Boolean”). Indeed, although the prediction datatype 302 defines a prediction value field 312, it does not define a particular parameter for the prediction value field (or it defines a general parameter that includes a variety of sub-parameter options). The prediction template 304, however, defines a Boolean prediction value parameter for the prediction key field 310. Thus, a prediction instance for the Synthetic Account Model will need to comply with the prediction value parameter 332 for the prediction value field 312 as defined by the prediction template 304.

In addition, the machine learning model prediction template 304 includes feature key names 334a, 334b corresponding to the feature key field 314 (that comply with the feature key parameter 314a). Specifically, the prediction template 304 includes a “Zip Code” feature key name 334a and an “Account Number” feature key name 334b. These feature key names also correspond to feature value parameters 336a, 336b. As illustrated, the feature value parameters 336a, 336b require that feature values for the “Zip Code” and “Account Number” feature key names for the “Synthetic Account Model” belong to an “Integer” data class.

Furthermore, FIG. 3 also illustrates a family name 338 corresponding to the family name field 318. As shown, the family name 338 also satisfies the parameter 318a. As discussed previously, multiple machine learning models can belong to the same machine learning model family. Thus, the family name 338 (i.e., “Synthetic Name”) can be shared across multiple prediction templates (e.g., across various synthetic prediction account models of various architectures, training approaches, versions, training data sources, etc.).

Similarly, FIG. 3 illustrates an additional prediction template 306. Like the prediction template 304, the prediction template 306 includes a model name 348, a prediction key name 350, a prediction value parameter 352, feature key names 354a-354b, feature value parameters 356a-356b, and a family name 358 based on the prediction datatype 302 and its corresponding fields and parameters. Thus, the machine learning platform system 102 can generate a variation of different prediction templates that satisfy the strictures of the prediction datatype 302 but that include unique parameters that correspond to individual machine learning models.

Like the prediction datatype 302, in one or more embodiments, the machine learning platform system 102 generates the prediction templates 304, 306 based on user interaction with one or more computing devices. For example, the machine learning platform system 102 can provider a user interface to the engineering device(s) 110a. The engineering device(s) 110a can interact with selectable options to define fields and/or associate parameters with those fields in generating the prediction datatype 302 and/or the prediction templates 304, 306.

In some embodiments, the machine learning platform system 102 automatically generates the prediction datatype 302 and/or the prediction templates 304, 306. For example, the machine learning platform system 102 can analyze existing machine learning models and identify pertinent fields/parameters utilized by the existing machine learning models to generate fields, parameters, names, or values. Thus, for example, the machine learning platform system 102 can analyze a variety of existing machine learning models and determine common fields and parameters across machine learning models to generate the prediction datatype 302. In some implementations the machine learning platform system 102 utilizes a threshold (e.g., 25% or 50% of models include a particular field or parameter) in generating a prediction datatype 302.

Although FIG. 3 illustrates a particular prediction datatype and prediction templates with particular fields and parameters, the machine learning platform system 102 can generate a variety of different prediction datatypes and prediction templates with different fields, values, and parameters. For example, the prediction datatype 302 and/or the prediction templates 304, 306 can include a combination of multiple parameters for individual fields (e.g., allow for “String,” “Boolean,” and/or “Integer” classes for a single field). Thus, a prediction datatype and/or prediction template can include parameters requiring a general “grammar” and instantiate particular details within a more detailed template or prediction instance (e.g., within a library). Similarly, the machine learning platform system 102 can tie two fields together. For example, the prediction key and prediction value (or feature key and feature value) can be defined as a key-value pair. In addition, in some implementations the prediction datatype and/or prediction templates other parameters, such as length of a particular field, sub-portions of a title, etc.

As mentioned previously, in some implementations, the machine learning platform system 102 also identifies or generates prediction instances corresponding to prediction templates. For example, FIG. 4 illustrates prediction instances 402, 404 corresponding to the prediction template 304.

In particular, each of the prediction instances 402, 404 reflect the results of applying a machine learning model to generate a machine learning model prediction for a particular entity. Specifically, the prediction instances 402, 404 reflects the results of applying the “Synthetic Account Model” to different entities having different zip codes and account numbers (and/or other entity features).

As illustrated, the machine learning platform system 102 generates the prediction instances 402, 404 according to the prediction template 304. Thus, for example, the machine learning platform system 102 generates the prediction instances 402, 404 with the name field 308 reflecting the name 328, the prediction key field 310 reflecting the prediction key name 330, and the feature key fields 314 reflecting the feature key names 334a, 334b.

In addition, the machine learning platform system 102 also generates the prediction instances 402, 404 to reflect individual entity details and results. Thus, the machine learning platform system 102 generates the prediction instances 402, 404 by populating the prediction value field 312 with the prediction values 412, 432 upon applying the machine learning model (i.e., “Yes” or “1” or some other Boolean indicator for the prediction value 412 and “No” or “0” for the prediction value 432). In addition, the machine learning platform system 102 populates feature value fields with entity features 416a-416b, 436a-436b applicable to the pertinent entity (i.e., “12345” for the Zip Code feature and “98765432′” for the Account Number feature). Notably, the machine learning platform system 102 generates these values in accordance with the parameters of the prediction template 304. In particular, the prediction value comports with the “Boolean” parameter defined by the prediction template 304 and the feature values comport with the “Integer” parameter defined by the prediction template 304.

The machine learning platform system 102 can require the prediction instances 402, 404 to align with the prediction template 304 in a variety of ways. For example, in some implementations, the machine learning platform system 102 monitors application of machine learning models, determines the pertinent values from application of the machine learning model, and compares the values with the parameters of the prediction template. If the values do not comport with the parameters of the prediction template, in some implementations, the machine learning platform system 102 automatically converts the values to satisfy the prediction template 304. In some implementations, the machine learning platform system 102 surfaces a notification to a computing device (e.g., provide a notification to a model engineering device indicating that the values do not comport with the prediction template).

In some embodiments, the machine learning platform system 102 requires registration of machine learning models before they can be launched. During this registration process, the machine learning platform system 102 can analyze features, predictions, or the architecture of the machine learning model for compliance with parameters of the pertinent prediction template. To illustrate, the machine learning platform system 102 can provide a user interface to an engineering device with selectable options indicating available prediction templates for machine learning models. The machine learning platform system 102 can receive selection of a prediction template and then compare the machine learning model with the prediction template to determine that the machine learning model satisfies parameters of the prediction template.

In one or more embodiments, the machine learning platform system 102 automatically suggests or selects a prediction template for a particular machine learning model. For example, the machine learning platform system 102 can analyze a title, architecture, engineering group, training data set, prediction type, historical selections of particular engineering device or group, or feature set corresponding to a machine learning model and predict the prediction template for the machine learning model. The machine learning platform system 102 can automatically assigning the prediction template and/or surface the prediction template to an engineering device for confirmation/selection in relation to a particular machine learning model.

Thus, the machine learning platform system 102 can apply a prediction template to prediction instances at a variety of times. Indeed, the machine learning platform system 102 can apply a prediction template during model registration, during model implementation, after model prediction, or in extracting predictions from a machine learning data repository and generating a low-latency machine learning prediction cache. In this manner, the machine learning platform system 102 can generate prediction templates that impose certain uniform parameters across machine learning models and additional uniform parameters within machine learning models/machine learning model families.

In addition, although FIGS. 3 and 4 illustrate a particular format of names, parameters, or values, the machine learning platform system 102 can utilize a variety of data forms. For example, in registering a new model, the machine learning platform system 102 can generate a template (or prediction record) where the new model synth_account_detection might have the model-specific INT feature new_user_registration_zip_code and BOOL prediction is_synth.

In addition, in one or more implementations, the machine learning platform system 102 also accommodates new versions of a prediction template for a given machine learning model. These updates can be nonbreaking (e.g., adding a new feature field) or breaking (e.g., dropping a feature field that a schema is looking for in fetching a prediction).

In one or more embodiments, the prediction datatypes, prediction templates, and prediction instances are enforced as part of a schema model (e.g., schema tooling model). For example, the machine learning platform system 102 can generate prediction instances as a set of Parquet files containing prediction record protobuf objects to a shared bucket. These prediction instances will contain model-specific fields and fields common to all models by adhering to types defined in an over-arching schema model (e.g., a central types repository that allows the system to share RPC, remote procedure call, service interfaces that utilize those types). The machine learning platform system 102 can allow engineering devices to modify these definitions (e.g., adding a new prediction column), by submitting a request to modify the prot file, resulting in automatic generation of updated packages utilizing the schema model. Accordingly, the machine learning platform system 102 can scale out prediction producers (e.g., to include third-party systems) without having to do further integration work related to prediction consumers (and vice versa). Additional detail regarding a schema model is described below (e.g., in relation to FIG. 5).

Accordingly, utilizing the foregoing approach, the machine learning platform system 102 can validate that prediction templates written to a persistence layer are complete, provide strongly-typed interfaces to external teams, react to updates, and autogenerate client code (e.g., to be distributed in package/germ form to external teams as described in greater detail below). Moreover, the machine learning platform system 102 can allow devices to query what models (and schema versions thereof) exist and can be queried while being informed of the availability of revised schema versions with breaking changes (so they can roll forward before older versions are deprecated) as described in greater detail below with regard to FIGS. 5-7.

As mentioned previously, in one or more embodiments, the machine learning platform system 102 surfaces current state machine learning model predictions from a low-latency machine learning prediction cache. FIG. 5 illustrates monitoring machine learning models 502 to generate a low-latency machine learning prediction cache 510 and provide current state machine learning model predictions 512.

As shown in FIG. 5, the machine learning platform system 102 monitors machine learning models 502. For example, the machine learning platform system 102 can collect predictions from the machine learning models and store these predictions within a machine learning data repository 504. To illustrate, the machine learning platform system 102 can interact with various production producing devices that execute real-time and/or batch inferences that generate machine learning model predictions. The machine learning platform system 102 can extract the predictions and corresponding details for permanent (or long-term) persistence of the predictions and related fields (e.g., entity features, timestamps, model versions, etc.). The machine learning platform system 102 can also access historical legacy machine learning models to determine machine learning model predictions and corresponding details.

In one or more embodiments, the machine learning data repository 504 stores the machine learning model predictions in a particular data structure. For example, the machine learning platform system 102 can store prediction instances in a parquet file within S3 (or another columnar data storage format). In one or more embodiments, for a given model and version, the fields present in these parquet files are the contents of the corresponding schema protobufs.

Indeed, as illustrated in FIG. 5, the machine learning platform system 102 can utilize a schema model 508 in generating and implementing the machine learning data repository 504 and/or the low-latency machine learning prediction cache 510. As mentioned above, the inter-network facilitation system 104 can utilize multiple servers hosting multiple compartmentalized components, modules, or services (with shared or independent processor(s)) to perform respective functions, where each of the network components processes data using its own respective data format. For instance, in response to a request from a client device to generate a new user account, the inter-network facilitation system 104 uses several network components to perform the processes involved in generating the new user account, including: 1) ingesting the client device request, 2) generating a digital payload codifying the request into computer readable code, 3) passing the digital payload to an account generation engine, and 4) providing a confirmation message to the client device upon successful generation of the user account. In many cases, the different network components perform their respective functions by processing data in a certain format, where formats can vary across network components. This process extends to components that rely on machine learning model predictions (e.g., in generating a new account, a component may call for a prediction as to whether a client device requesting the new account is synthetic or fraudulent). The machine learning platform system 102 can utilize the schema model 508 to determine a payload schema for converting a digital payload from a source format to a target format using a payload conversion code generator.

For example, the schema model 508 can include a computer-implemented approach to centralize message types and service interfaces via a GitHub repo for protobuf definitions. Thus, the schema model 508 can convert digital payloads from an input format to a target format in generating the low-latency machine learning prediction cache 510. Similarly, the schema model 508 can convert digital payloads from an existing format for digital data stored in the low-latency machine learning prediction cache 510 to an output format (e.g., in responding to queries across different systems or components).

In one or more embodiments, the machine learning platform system 102 utilizes the schema centralization and management approach described in GENERATING AND UPDATING PAYLOAD SCHEMAS FOR MAINTAINING COMPATIBILITY IN EVOLVING DIGITAL SYSTEMS, U.S. application Ser. No. 17/930,623, filed Sep. 8, 2022, which is incorporated by reference herein. Thus, the machine learning platform system 102 can utilize this schema approach to generate client or service code from a protobuf and track extant protobuf versions. Moreover, as described below (e.g., in relation to FIG. 6), the machine learning platform system 102 can utilize a prediction-fetching interface consistent with schema autogenerated clients, providing typed protobuf prediction fetches across models.

As shown in FIG. 5, the machine learning platform system 102 can utilizes these schema protobuf definitions in generating the machine learning data repository 504 and/or the low-latency machine learning prediction cache 510. Thus, the schema protobuf definitions can include the prediction templates discussed above (e.g., with regard to FIGS. 3-4). The machine learning platform system 102 can generate entries within the machine learning data repository 504 that include the schema protobufs and/or generate entries within the low-latency machine learning prediction cache 510 that include the schema protobufs. For example, in some implementations the machine learning platform system 102 stores JSON string encodings of a protobuf. In one or more embodiments, the machine learning platform system 102 stores a model agnostic protobuf.

In one or more embodiments, queries will look up the unique cached prediction value for a given model name/schema family and entity. Thus, the machine learning platform system 102 can utilize (schema_name) #(schema_version) #(entity_int) for the schema design. In some implementations, the machine learning platform system 102 utilizes database partition keys to quickly and efficiently perform inexpensive lookups based on name and entity (minimizing more expensive lookups). The machine learning platform system 102 can support operations using a variety of communication frameworks including Twirp (i.e., an OSS microservice communication framework similar to gRPC available in a variety of languages). Accordingly, the machine learning platform system 102 can implement client and server implementations for a given RPC service. In one or more implementations, the schema model 508 supports auto generation of Ruby, Go, and Python 3 client+server code for protobufs that define services.

In one or more embodiments, the machine learning platform system 102 utilizes a particular set of prefixes to help ensure that writes from a batch prediction job will have an associated prefix available (e.g., to ensure that different batch jobs from the same model on the same day would not write objects to the same prefix, resulting in mixed batches). For example, as shown, the machine learning platform system 102 can utilizes ENV to designate an account environment (e.g., production), MODEL_FAMILY to designate a model family (present in schemas), DATESTAMP (e.g., YYYY_MM_DD), and/or DATETIMESTAMP (e.g., YYY_MM_DD_HH_MM_SS), as illustrated in FIG. 5.

In some implementations, the machine learning platform system 102 also utilizes prefixes to differentiate between active state models and models in other states (e.g., experimental states, shadow states, etc.). In one or more implementations, the machine learning platform system 102 also utilizes a state indicator to determine this from the prefix (instead of scanning the contents of the prediction instance record). Accordingly, in some embodiments, the machine learning platform system 102 utilizes a MODEL_SHADOW prefix as illustrated in FIG. 5.

Similarly, in some circumstances, a given machine learning model family may have a series of breaking version changes. In some embodiments, the machine learning platform system 102 provides version information (e.g., within an upgrade window). In one or more implementations, the machine learning platform system 102 writes the predictions in two or more formats so that clients can upgrade to the new major version (but aren't broken immediately). The machine learning platform system 102 can load and serve both formats during the upgrade window. Accordingly, in some embodiments, the machine learning platform system 102 also utilizes a SCHEMA_VERSION prefix as illustrated in FIG. 5.

As illustrated in FIG. 5, the machine learning platform system 102 can utilize a family and current status filter 506 to generate a low-latency machine learning prediction cache 510 from the machine learning data repository 504. For example, the machine learning platform system 102 can extract all models and predictions for a particular family. The machine learning platform system 102 can sort or rank the predictions based on recency to identify the most recent prediction. The machine learning platform system 102 then extracts the prediction with the most current status for the model family.

In one or more embodiments, the machine learning platform system 102 extracts a current status machine learning model prediction for each machine learning model (instead of for each family). In such embodiments, the machine learning platform system 102 thus generates multiple current status machine learning model predictions within the low-latency machine learning prediction cache 510 for machine learning model families having multiple models.

As shown, the machine learning platform system 102 can utilize the schema model 508 in generating the low-latency machine learning prediction cache 510. For instance, as discussed above, the machine learning platform system 102 can populate the low-latency machine learning prediction cache 510 utilize schema protobuf definitions (corresponding to the registration process described above in relation to prediction datatype and prediction templates). Thus, even in the event that the machine learning data repository 504 is not aligned to schema definitions, the machine learning platform system 102 can align entries to the schema definitions in generating the low-latency machine learning prediction cache 510.

As illustrated, the machine learning platform system 102 can then utilize the low-latency machine learning prediction cache 510 to serve current state machine learning model predictions 512. Indeed, the machine learning platform system 102 can provide a lightweight API to receive and respond to queries for the current state machine learning model predictions 512. Because the current state machine learning model predictions 512 are extracted from the low-latency machine learning prediction cache 510 according to the schema definitions, the machine learning platform system 102 can efficiently, quickly, and accurately provide the current state machine learning model predictions 512 across a variety of different platforms and services. Indeed, the machine learning platform system 102 can further utilize the schema model 508 to convert digital payloads from a source format in the low-latency machine learning prediction cache 510 to a target format for a different system component using a payload conversion code generator of the schema model 508.

As mentioned above, in one or more embodiments, the machine learning platform system 102 receives queries for machine learning model predictions and serves current state machine learning model predictions from a low-latency machine learning prediction cache via an application programming interface. For example, FIG. 6 illustrates receiving a query for a machine learning model and entity from a computing device 602 and providing a current state machine learning model prediction to the computing device 602 utilizing an RPC web service 614 (or an API) and a low-latency machine learning prediction cache 616.

Specifically, FIG. 6 illustrates a user interface 604 on a display screen of the computing device 602. The user interface 604 includes a machine learning model search element 606. Based on user input 606a via the machine learning model search element 606, the machine learning platform system 102 searches for machine learning models. In relation to FIG. 6, the machine learning platform system 102 searches machine learning model names registered via the machine learning platform system 102 (as described in relation to FIGS. 3-4). Indeed, the machine learning platform system 102 registers machine learning model names as part of generating machine learning model templates and/or machine learning model instances. The machine learning platform system 102 searches these names based on the user input 606a (e.g., by performing a word search, key word search, or other searching method).

As illustrated, the machine learning platform system 102 provides a response 608 that includes a first model 608a and a second model 608b. Although only two machine learning models are illustrated, the machine learning platform system 102 can identify a variety of different machine learning models depending on the circumstances of the query and the matching models. Moreover, the machine learning platform system 102 can receive a user interaction of a particular model from the response 608. For example, in relation to FIG. 6, the machine learning platform system 102 receives a selection of the first model 608a (i.e., “Synthetic Account Model”).

As shown in FIG. 6, the machine learning platform system 102 also provides an entity query search element 610 via the user interface 604. Indeed, the machine learning platform system 102 provides an indicator 612 of the selected machine learning model (i.e., “Synthetic Account Model”) and includes a prompt regarding the entity corresponding to the selected machine learning model. In relation to FIG. 6, the machine learning platform system 102 provides an entity query search element 610 corresponding to a particular entity feature (i.e., “Account Number”). The machine learning platform system 102 can provide different or additional entity query search elements 610 corresponding to various entity features (e.g., for entity features defined within a machine learning model template or machine learning model instances as described in relation to FIGS. 3, 4). For example, the machine learning platform system 102 can access a machine learning model template corresponding to the selected machine learning model to identify the pertinent entity features corresponding to the machine learning model. The machine learning platform system 102 can then provide selectable entity query search elements for one or more of these entity features.

As shown, the machine learning platform system 102 receives user input 610a via the entity query search element 610. In particular, the machine learning platform system 102 provides input of “987654321” via the entity query search element 610. The machine learning platform system 102 can receive various types of user input via various types of user interface elements (e.g., selection of an item via a drop down menu, selection of one or more radio buttons, etc.).

The machine learning platform system 102 utilizes the identifies machine learning model (“Synthetic Account Model”) and entity (account number “987654321”) and utilizes the RPC web service 614 to obtain a current state machine learning model prediction for the selected model and entity. As discussed previously, the machine learning platform system 102 can utilize a well-defined API that mimics the partition key of the low-latency machine learning prediction cache 616. Indeed, because the low-latency machine learning prediction cache 616 includes well-defined entries that comport with pertinent schema definitions (and prediction datatype/prediction templates) the machine learning platform system 102 can utilize an efficient and accurate API to extract and surface current state machine learning model predictions from the low-latency machine learning prediction cache 616. Indeed, in one or more embodiments, the machine learning platform system 102 services individual predictions via low-latency synchronous RPC requests.

Thus, the machine learning platform system 102 can extract the most recent machine learning model prediction for the selected machine learning model and entity via the low-latency machine learning prediction cache 616. As discussed above, the machine learning platform system 102 can efficiently determine the current state machine learning model predictions. Indeed, the low-latency machine learning prediction cache 616 is an online database (with low latency), the cache includes current state machine learning model predictions (instead of all predictions for machine learning models), and the machine learning platform system 102 can utilize a simplified key pattern to identify the pertinent predictions. For example, the machine learning platform system 102 can utilize a partition key (consistent with the schema discussed above) for a current state machine learning model table and calculated suffixes in the partition key for a sharding strategy.

In one or more embodiments, the partition key includes a machine learning model use case/name, model version, and entity name-value pairs for entities defined in the prediction record (e.g., prediction template). In one or more implementations, the machine learning platform system 102 sorts the entity name-value pairs by entity name, as follows:
{ml-use-case}#model_version:{mv-value}#{entity1_name}:{entity1_value}#{entity2_name}: {entity2_value} . . .
Thus, an example partition key can include:
mcd_risk_score #model_version:v1 #account_number:1234 #routing_number:0001

Upon extracting the current state machine learning model prediction, the machine learning platform system 102 also provides the current state machine learning model prediction (via the RPC web service 614) to the computing device 602. For example, FIG. 6 illustrates the machine learning platform system 102 providing a current state machine learning model prediction 620 via the user interface 604 of the client device 602 with the machine learning model indicator 612.

Although FIG. 6 illustrates a particular machine learning model prediction, the machine learning platform system 102 can surface a variety of machine learning model predictions. For example, in some embodiments, the machine learning platform system 102 provides a categorical prediction (e.g., a class), a score (e.g., a risk score), and/or a probability (e.g., a likelihood that an account is synthetic).

In addition, although FIG. 6 illustrates receiving and providing a query via a user interface of a computing device, the machine learning platform system 102 can also operate with regard to headless computing devices (without displays or user interfaces). For example, in response to receiving a request for an increased credit limit of an account, a server can automatically initiate a request for a machine learning model prediction corresponding to the account. The machine learning platform system 102 can utilize the process of FIG. 6 to provide a current status machine learning model prediction for the account (efficiently and quickly) so that the server can make an automatic determination regarding the increased credit limit.

Moreover, although FIG. 6 illustrates selecting a machine learning model based on user interaction, in some embodiments, the machine learning platform system 102 automatically determines a pertinent machine learning model. For example, the machine learning platform system 102 can select a pertinent machine learning model based on historical requests, a group or entity name, or a query intent/purpose.

The machine learning platform system 102 can utilize a variety of machine learning models, and a variety of machine learning model predictions, for a variety of different prediction requester services. For example, in one or more embodiments, the machine learning platform system 102 utilizes a machine learning model to generate client disposition classification predictions as described by UTILIZING MACHINE LEARNING MODELS TO PREDICT CLIENT DISPOSITIONS AND GENERATE ADAPTIVE AUTOMATED INTERACTION RESPONSES, U.S. application Ser. No. 17/554,795, filed Dec. 17, 2021, which is incorporated herein by reference in its entirety. In response to receiving an interaction with a client device, the machine learning platform system 102 can provide a current state client disposition classification prediction corresponding to system components for generating automated interaction responses to the client device and/or for providing client intent predictions to agent devices.

Similarly, the machine learning platform system 102 can utilize the machine learning model described by UTILIZING MACHINE LEARNING MODELS TO GENERATE INTERACTIVE DIGITAL TEXT THREADS WITH PERSONALIZED DIGITAL TEXT REPLY OPTIONS, U.S. application Ser. No. 17/809,765, filed Jun. 29, 2022, which is incorporated herein by reference in its entirety. In response to receiving a real-time interactive text communication from a client device, the machine learning platform system 102 can provide a current state client intent classification prediction corresponding to the client device to system components for generating personalized digital text reply options.

Similarly, in some implementations, the machine learning platform system 102 utilizes machine learning models to predict security threats (e.g., predict fraudulent transactions, fraudulent access to client accounts, fraudulent transaction disputes, or other fraudulent conduct) as described by UTILIZING A FRAUD PREDICTION MACHINE LEARNING MODEL TO INTELLIGENTLY GENERATE FRAUD PREDICTIONS FOR NETWORK TRANSACTIONS, U.S. application Ser. No. 17/546,410, filed Dec. 9, 2021; GENERATING A FRAUD PREDICTION UTILIZING A FRAUD-PREDICTION MACHINE LEARNING MODEL, U.S. application Ser. No. 17/545,890, filed Dec. 8, 2021; or UTILIZING MACHINE LEARNING MODELS TO DETERMINE TAKE-OVER SCORES AND INTELLIGENTLY SECURE DIGITAL ACCOUNT FEATURES, U.S. application Ser. No. 17/574,144, filed Jan. 12, 2022, which are incorporated herein by reference in their entirety. The machine learning platform system 102 can generate current state machine learning model predictions from these models and provide the current state machine learning models to a variety of system components, such as risk evaluation components, account approval components, transaction analysis components, or web/mobile authentication components.

Similarly, in one or more implementations, the machine learning platform system 102 utilizes a machine learning model as a risk prediction model that generates activity scores and predicted base limit values for digital accounts as described in GENERATING USER INTERFACES COMPRISING DYNAMIC BASE LIMIT VALUE USER INTERFACE ELEMENTS DETERMINED FROM A BASE LIMIT VALUE MODEL, U.S. application Ser. No. 17/519,129, filed Nov. 4, 2021, and incorporated by reference herein in its entirety. The machine learning platform system 102 can generate and provide the current state machine learning model predictions for providing accurate and timely base limit values for individual accounts and for user interfaces corresponding to client devices.

Moreover, in one or more embodiments, the machine learning platform system 102 utilizes the machine learning training and implementation approach as part of a machine learning pipeline, as described in TRAINING AND IMPLEMENTING MACHINE LEARNING MODELS UTILIZING MODEL CONTAINER WORKFLOWS, U.S. application Ser. No. 17/578,222, filed Jan. 18, 2022, which is incorporated by reference herein in its entirety. Indeed, the machine learning platform system 102 can utilize of model container workflows as described in U.S. application Ser. No. 17/578,222 to generate machine learning model predictions and collect these machine learning model predictions for efficient and accurate distribution utilizing a low-latency machine learning prediction cache.

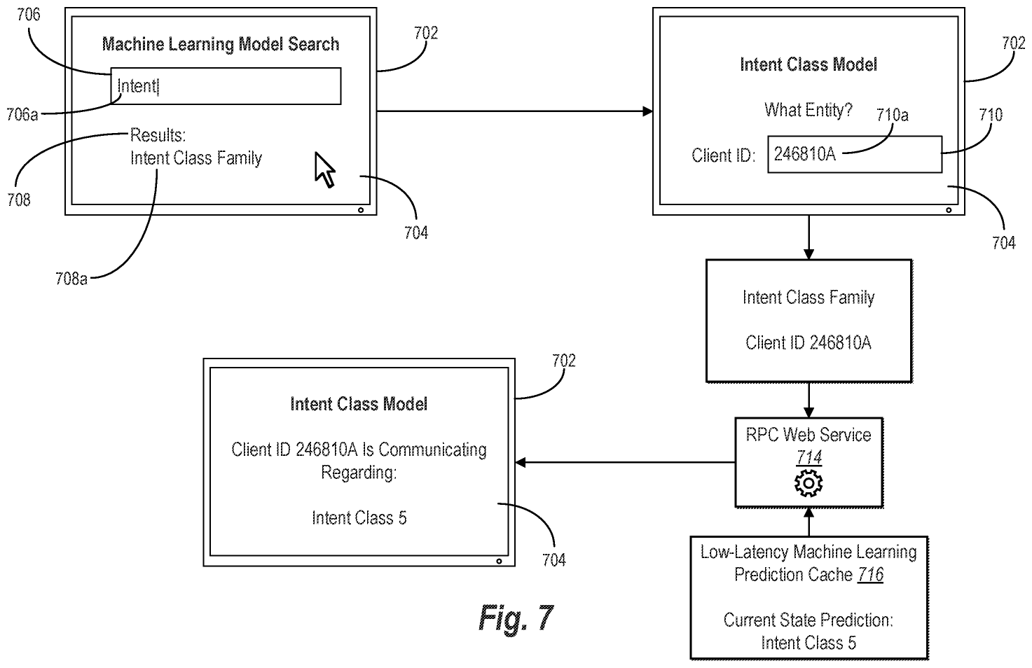

As mentioned above, although FIG. 6 illustrates identifying a current state machine learning model prediction for a specific model, in some instances, the machine learning platform system 102 operates by analyzing machine learning model families. For example, FIG. 7 illustrates a computing device 702 displaying a user interface 704 that includes a search element 706. Based on user input 706a of the search element 706, the machine learning platform system 102 provides a query result 708 including a machine learning model family 708a by searching registered machine learning model families. Moreover, the machine learning platform system 102 provides an entity query search element 710 via the user interface 704. In particular, the entity query search element 710 receives user input 710a for an entity feature (i.e., “Client ID”) defined by a prediction template corresponding to the machine learning model family.

Similar to the approach described in FIG. 6, the machine learning platform system 102 generates a query that includes the selected machine learning model family (i.e., “Intent Class Family”) and the entity (i.e., “Client ID 246810A”) and submits the query to the RPC web service 714 (e.g., similar to the RPC web service 614 or API discussed above that provides current state machine learning models for machine learning model families).

For example, in one or more implementations, the machine learning platform system 102 utilizes the following pseudo-code to fetch the most recent machine learning model prediction for a given entity:

```
service MerlinAPI {
  // Lists all existing model families.
  rpc ListModelFamilies(ListModelFamiliesRequest) returns
  (ListModelFamiliesResponse);
  // Lists all models for a particular family.
  rpc ListModelsForFamily(ListModelsForFamilyRequest) returns
  (ListModelsForFamilyResponse);
  // Returns prediction for a particular model and entity.
  rpc GetPrediction(GetPredictionRequest) returns
(GetPredictionResponse);
}
message ListModelFamiliesRequest { }
message ListModelFamiliesResponse {repeated string families = 1;}
message ListModelsForFamilyRequest {string family = 1;}
message ListModelsForFamilyResponse {repeated chime.ml.records.v1.Model
models = 1;}
message GetPredictionRequest {
  chime.ml.records.v1.Model model = 1;
  int64 entity = 2;
}
message GetPredictionResponse {chime.ml.records.v1.Predictions predictions = 1;}
```

Accordingly, the machine learning platform system 102 extracts the current state machine learning model for the selected machine learning model family and entity from the low-latency machine learning prediction cache 716. The low-latency machine learning prediction cache 716 includes (for each machine learning model family) the most current prediction for models within the machine learning model family. Thus, the machine learning platform system 102 efficiently extracts the current state machine learning model prediction (i.e., “Intent Class 5”) for the selected machine learning model (i.e., “Intent Class Model”) and entity (i.e., “Client ID 246810A”).

As shown in FIG. 7, the machine learning platform system 102 also provides the current state machine learning model prediction via the user interface 704 of the computing device 702. Thus, the computing device 702 and corresponding user have the predicted intent for a particular entity (e.g., for client 246810A communication with the inter-network facilitation system 104). Although FIG. 7 illustrates providing a single classification prediction, in some implementations, the machine learning platform system 102 provides multiple classification predictions and corresponding probabilities/confidence scores (e.g., class 5 at 90% and class 2 at 10%).

In some implementations, the machine learning platform system 102 can also utilize routing logic to serve particular machine learning model predictions (e.g., to assist in experimentation). For example, the machine learning platform system 102 can identify two machine learning models in the same machine learning model family. To experiment across the machine learning models, the machine learning platform system 102 can serve a first portion (e.g., a first half) of requests with current state machine learning model predictions from the first model and serve a second portion (e.g., a second half) of requests with current state machine learning model predictions from the second model.

Notably, the machine learning platform system 102 provides machine learning model predictions to computing devices with very limited information required from the requesting devices. Indeed, the requesting computing devices of FIG. 7 does not need to provide information regarding versions, architectures, prediction timelines, experimentation states, etc. The machine learning platform system 102 allows requesting computing device to search for and select a needed model (or model family) and receive the current state machine learning prediction for a particular entity.

Although FIGS. 6-7 illustrate providing a current state machine learning model prediction, the machine learning platform system 102 can also perform other analysis or look up procedures in other embodiments. Indeed, in some implementations, the machine learning platform system 102 provides multiple APIs (and multiple caches) for different lookup procedures. For example, in some implementations, the machine learning platform system 102 provides an interface for batch lookup of machine learning model predictions. In some, implementations, the machine learning platform system 102 provides an interface for historic lookup of machine learning model predictions (e.g., a chronology of predictions over time for a machine learning model and entity). Moreover, in some implementations, the machine learning platform system 102 can utilize an asynchronous queue based interface (e.g., on top of the synchronous queue).

Moreover, in some implementations, the machine learning platform system 102 utilizes dedicated nodes/pods per prediction consumer. Thus, if a particular system component submits a large volume of requests, the machine learning platform system 102 any potential disruption will impact a particular node or pod instead of the entire framework.

In one or more embodiments, the machine learning platform system 102 also implements separate security and authentication procedures for prediction consumers (e.g., individual devices or groups). Thus, for example, the machine learning platform system 102 can set access limitations (e.g., particular available machine learning predictions) for a first group that differ for a second group. Indeed, a first group that handles risk analysis may be able to access sensitive risk predictions for a risk machine learning model while a second group that handles member interactions may be excluded from the sensitive risk predictions and the risk machine learning model. In some implementations, the machine learning platform system 102 identifies a first set of machine learning model predictions accessible to a first group (e.g., 5 particular models) and a second set of machine learning model predictions accessible to a second group (e.g., 10 particular models).

Moreover, although not illustrated, in some implementations, the machine learning platform system 102 also implements additional security and privacy protocols. For instance, the machine learning platform system 102 can also protect personal identifiable information (PII). For example, the machine learning platform system 102 can identify particular feature columns as PII feature columns. In this manner, the machine learning platform system 102 can implement app-level PI restrictions. For instance, the machine learning platform system 102 the machine learning platform system 102 can require additional credentials (e.g., PII allow list) for clients that wish to access machine learning model predictions based on PII. Similarly, the machine learning platform system 102 can drop or exclude PII fields before they are promulgated outside of protected databases or servers.

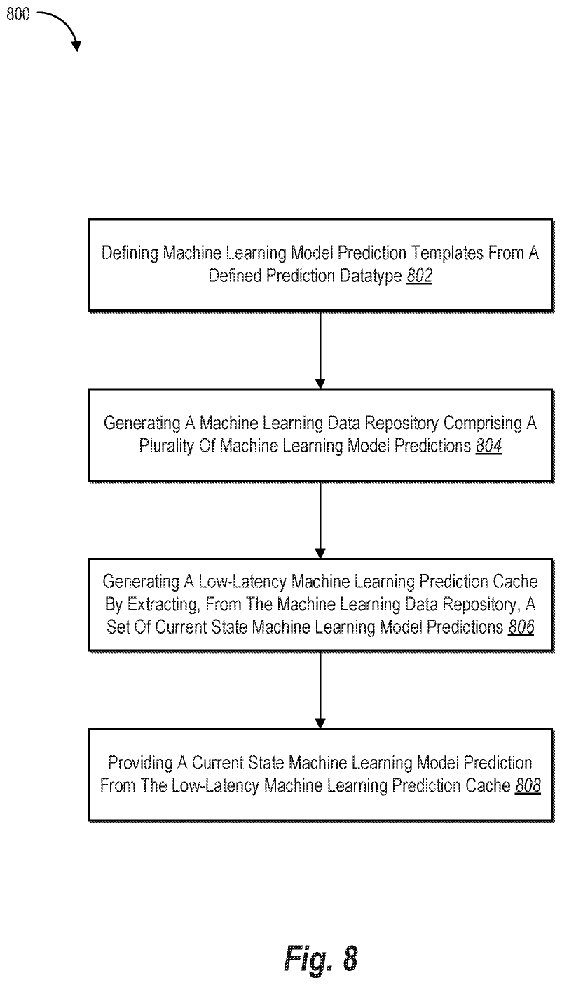

FIGS. 1-7, the corresponding text, and the examples provide a number of different systems, methods, and non-transitory computer readable media for utilizing a neural network and a high-dimensionality tabular data set to generate a prediction. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for providing machine learning model predictions utilizing a low-latency machine learning prediction cache in accordance with one or more embodiments. As illustrated, in one or more implementations, the series of acts 800 include acts 802-808 of defining machine learning model prediction templates from a defined prediction datatype; generating a machine learning data repository comprising a plurality of machine learning model predictions; generating a low-latency machine learning prediction cache by extracting, from the machine learning data repository, a set of current state machine learning model predictions; and providing a current state machine learning model prediction from the low-latency machine learning prediction cache.

For example, in one or more implementations, the acts 802-808 include defining machine learning model prediction templates corresponding to a plurality of machine learning models from a defined prediction datatype; generating a machine learning data repository comprising a plurality of machine learning model predictions generated from input features utilizing the plurality of machine learning models; generating a low-latency machine learning prediction cache by extracting, from the machine learning data repository, a set of current state machine learning model predictions from the plurality of machine learning model predictions according to the machine learning prediction templates; and in response to receiving a query for a machine learning model prediction, providing a current state machine learning model prediction from the set of current state machine learning model predictions of the low-latency machine learning prediction cache.

In one or more embodiments, extracting the set of current state machine learning model predictions comprises, for a machine learning model: identifying a set of machine learning model predictions corresponding to the machine learning model; and selecting the current state machine learning model prediction by ranking the set of machine learning model predictions according to recency. In some embodiments, the low-latency machine learning prediction cache has a lower latency than the machine learning data repository.

Moreover, in one or more embodiments, the series of acts 800 includes generating the defined prediction datatype by defining a name field, a machine learning model prediction field, and a machine learning model entity feature field.

In some implementations, the series of acts 800 includes defining a machine learning model prediction template of the machine learning model prediction templates for a machine learning model by populating the name field of the defined prediction datatype with a machine learning model name, defining prediction data parameters of the machine learning model prediction field, and defining entity feature data parameters of the machine learning model entity feature field.

Further, in one or more implementations, the series of acts 800 includes generating the set of current state machine learning model predictions by generating a machine learning model prediction instance comprising the machine learning model name, a machine learning model prediction value consistent with the prediction data parameters of the machine learning prediction template, and an entity feature data value consistent with the feature data parameters of the machine learning prediction template.

In addition, in one or more embodiments, receiving the query comprises receiving a machine learning model name and a machine learning model feature identifier corresponding to the entity feature data value of the machine learning model prediction instance.

Moreover, in one or more implementations generating the low-latency machine learning prediction cache comprises: identifying a plurality of machine learning model families from the plurality of machine learning models; and extracting a current state machine learning model prediction for each machine learning model family of the plurality of machine learning model families.

In one or more embodiments, receiving the query for the machine learning model prediction comprises receiving a machine learning model family name identifier; and providing the current state machine learning model prediction comprises: identifying a machine learning model family corresponding to the machine learning model family name identifier; identifying a set of machine learning models and a set of machine learning model predictions corresponding to the machine learning model family; and selecting the current state machine learning model prediction by ranking the set of machine learning model predictions for the set of machine learning models according to recency.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the client device(s) 110a-110c, or the server(s) 106) that may be configured to perform one or more of the processes described above. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the inter-network facilitation system 104. The network environment 1000 includes a client device 1006 (e.g., the client devices 110a-110c), an inter-network facilitation system 104, and a third-party system 1008 connected to each other by a network 1004. Although FIG. 10 illustrates a particular arrangement of the client device 1006, the inter-network facilitation system 104, the third-party system 1008, and the network 1004, this disclosure contemplates any suitable arrangement of client device 1006, the inter-network facilitation system 104, the third-party system 1008, and the network 1004. As an example, and not by way of limitation, two or more of client device 1006, the inter-network facilitation system 104, and the third-party system 1008 communicate directly, bypassing network 1004. As another example, two or more of client device 1006, the inter-network facilitation system 104, and the third-party system 1008 may be physically or logically co-located with each other in whole or in part.

Moreover, although FIG. 10 illustrates a particular number of client devices 1006, inter-network facilitation systems 104, third-party systems 1008, and networks 1004, this disclosure contemplates any suitable number of client devices 1006, inter-network facilitation system 104, third-party systems 1008, and networks 1004. As an example, and not by way of limitation, network environment 1000 may include multiple client device 1006, inter-network facilitation system 104, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006 and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 10. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1004) to link the third-party-system 1008. For example, the inter-network facilitation system 104 may receive authentication credentials from a user to link a third-party system 1008 such as an online bank account, credit account, debit account, or other financial account to a user account within the inter-network facilitation system 104. The inter-network facilitation system 104 can subsequently communicate with the third-party system 1008 to detect or identify balances, transactions, withdrawal, transfers, deposits, credits, debits, or other transaction types associated with the third-party system 1008. The inter-network facilitation system 104 can further provide the aforementioned or other financial information associated with the third-party system 1008 for display via the client device 1006. In some cases, the inter-network facilitation system 104 links more than one third-party system 1008, receiving account information for accounts associated with each respective third-party system 1008 and performing operations or transactions between the different systems via authorized network connections.

In particular embodiments, the inter-network facilitation system 104 may interface between an online banking system and a credit processing system via the network 1004. For example, the inter-network facilitation system 104 can provide access to a bank account of a third-party system 1008 and linked to a user account within the inter-network facilitation system 104. Indeed, the inter-network facilitation system 104 can facilitate access to, and transactions to and from, the bank account of the third-party system 1008 via a client application of the inter-network facilitation system 104 on the client device 1006. The inter-network facilitation system 104 can also communicate with a credit processing system, an ATM system, and/or other financial systems (e.g., via the network 1004) to authorize and process credit charges to a credit account, perform ATM transactions, perform transfers (or other transactions) across accounts of different third-party systems 1008, and to present corresponding information via the client device 1006.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1008), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1000 either directly or via network 1004. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1004.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1006. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1004. A third-party system 1008 can communicate with the inter-network facilitation system 104 to provide financial information pertaining to balances, transactions, and other information, whereupon the inter-network facilitation system 104 can provide corresponding information for display via the client device 1006. In particular embodiments, a third-party system 1008 communicates with the inter-network facilitation system 104 to update account balances, transaction histories, credit usage, and other internal information of the inter-network facilitation system 104 and/or the third-party system 1008 based on user interaction with the inter-network facilitation system 104 (e.g., via the client device 1006). Indeed, the inter-network facilitation system 104 can synchronize information across one or more third-party systems 1008 to reflect accurate account information (e.g., balances, transactions, etc.) across one or more networked systems, including instances where a transaction (e.g., a transfer) from one third-party system 1008 affects another third-party system 1008.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
defining machine learning model prediction templates corresponding to a plurality of machine learning models from a defined prediction datatype;
generating a machine learning data repository comprising a plurality of machine learning model predictions generated from input features utilizing the plurality of machine learning models;
generating a low-latency machine learning prediction cache by extracting, from the machine learning data repository, a set of current state machine learning model predictions from the plurality of machine learning model predictions according to the machine learning prediction templates; and
in response to receiving a query for a machine learning model prediction, providing a current state machine learning model prediction from the set of current state machine learning model predictions of the low-latency machine learning prediction cache.

2. The computer-implemented method of claim 1, wherein extracting the set of current state machine learning model predictions comprises, for a machine learning model:
identifying a set of machine learning model predictions corresponding to the machine learning model; and
selecting the current state machine learning model prediction by ranking the set of machine learning model predictions according to recency.

3. The computer-implemented method of claim 1, wherein the low-latency machine learning prediction cache has a lower latency than the machine learning data repository.

4. The computer-implemented method of claim 1, further comprising generating the defined prediction datatype by defining a name field, a machine learning model prediction field, and a machine learning model entity feature field.

5. The computer-implemented method of claim 4, further comprising defining a machine learning model prediction template of the machine learning model prediction templates for a machine learning model by populating the name field of the defined prediction datatype with a machine learning model name, defining prediction data parameters of the machine learning model prediction field, and defining entity feature data parameters of the machine learning model entity feature field.

6. The computer-implemented method of claim 5, further comprising generating the set of current state machine learning model predictions by generating a machine learning model prediction instance comprising the machine learning model name, a machine learning model prediction value consistent with the prediction data parameters of the machine learning prediction template, and an entity feature data value consistent with the feature data parameters of the machine learning prediction template.

7. The computer-implemented method of claim 6, wherein receiving the query comprises receiving a machine learning model name and a machine learning model feature identifier corresponding to the entity feature data value of the machine learning model prediction instance.

8. The computer-implemented method of claim 1, wherein generating the low-latency machine learning prediction cache comprises:
identifying a plurality of machine learning model families from the plurality of machine learning models; and
extracting a current state machine learning model prediction for each machine learning model family of the plurality of machine learning model families.

9. The computer-implemented method of claim 1, wherein,
receiving the query for the machine learning model prediction comprises receiving a machine learning model family name identifier; and
providing the current state machine learning model prediction comprises:
identifying a machine learning model family corresponding to the machine learning model family name identifier;
identifying a set of machine learning models and a set of machine learning model predictions corresponding to the machine learning model family; and
selecting the current state machine learning model prediction by ranking the set of machine learning model predictions for the set of machine learning models according to recency.

10. A non-transitory computer-readable medium storing instructions that, when executed by at least one processor, cause a computer system to:
define machine learning model prediction templates corresponding to a plurality of machine learning models from a defined prediction datatype;
generate a machine learning data repository comprising a plurality of machine learning model predictions generated from input features utilizing the plurality of machine learning models;
generate a low-latency machine learning prediction cache by extracting, from the machine learning data repository, a set of current state machine learning model predictions from the plurality of machine learning model predictions according to the machine learning prediction templates; and
in response to receiving a query for a machine learning model prediction, provide a current state machine learning model prediction from the set of current state machine learning model predictions of the low-latency machine learning prediction cache.

11. The non-transitory computer-readable medium of claim 10, wherein the instructions, when executed by the at least one processor, further cause the computer system to extract the set of current state machine learning model predictions by, for a machine learning model:
identifying a set of machine learning model predictions corresponding to the machine learning model; and
selecting the current state machine learning model prediction by ranking the set of machine learning model predictions according to recency.

12. The non-transitory computer-readable medium of claim 10, wherein the low-latency machine learning prediction cache has a lower latency than the machine learning data repository.

13. The non-transitory computer-readable medium of claim 10, wherein the instructions, when executed by the at least one processor, further cause the computer system to generate the defined prediction datatype by defining a name field, a machine learning model prediction field, and a machine learning model entity feature field.

14. The non-transitory computer-readable medium of claim 13, wherein the instructions, when executed by the at least one processor, further cause the computer system to define a machine learning model prediction template of the machine learning model prediction templates for a machine learning model by populating the name field of the defined prediction datatype with a machine learning model name, defining prediction data parameters of the machine learning model prediction field, and defining entity feature data parameters of the machine learning model entity feature field.

15. The non-transitory computer-readable medium of claim 14, wherein the instructions, when executed by the at least one processor, further cause the computer system to generate the set of current state machine learning model predictions by generating a machine learning model prediction instance comprising the machine learning model name, a machine learning model prediction value consistent with the prediction data parameters of the machine learning prediction template, and an entity feature data value consistent with the feature data parameters of the machine learning prediction template.

16. The non-transitory computer-readable medium of claim 15, wherein the instructions, when executed by the at least one processor, further cause the computer system to receive the query by receiving a machine learning model name and a machine learning model feature identifier corresponding to the entity feature data value of the machine learning model prediction instance.

17. A system comprising:
at least one processor; and
at least one non-transitory computer-readable storage medium storing instructions that, when executed by the at least one processor, cause the system to:
define machine learning model prediction templates corresponding to a plurality of machine learning models from a defined prediction datatype;
generate a machine learning data repository comprising a plurality of machine learning model predictions generated from input features utilizing the plurality of machine learning models;
generate a low-latency machine learning prediction cache by extracting, from the machine learning data repository, a set of current state machine learning model predictions from the plurality of machine learning model predictions according to the machine learning prediction templates; and
in response to receiving a query for a machine learning model prediction, provide a current state machine learning model prediction from the set of current state machine learning model predictions of the low-latency machine learning prediction cache.

18. The system of claim 17, further comprising instructions that, when executed by the at least one processor, cause the system to extract the set of current state machine learning model predictions by, for a machine learning model:
identifying a set of machine learning model predictions corresponding to the machine learning model; and
selecting the current state machine learning model prediction by ranking the set of machine learning model predictions according to recency.

19. The system of claim 17, wherein the low-latency machine learning prediction cache has a lower latency than the machine learning data repository.

20. The system of claim 17, further comprising instructions that, when executed by the at least one processor, cause the system to generate the defined prediction datatype by defining a name field, a machine learning model prediction field, and a machine learning model entity feature field.
